(19) United States
(12) Patent Application Publication
(10) Pub. No.: US 2011/0126974 A1
(43) Pub. Date: Jun. 2, 2011

(54) Method for manufacture of designer blended boards

(76) Inventor: Robert Todd Harrison, Fallon, NV (US)

(21) Appl. No.: 12/592,568

(22) Filed: Nov. 27, 2009

(51) Int. Cl. B32B 38/04

(52) U.S. Cl. 156/258

(57) ABSTRACT

A method for fabricating board(s) from different types of wood or other materials in combination. Whereby the end result is a board(s) having a unique design formed thereon resulting from different intermixed colours and species of the different blended materials and/or woods therein. The method includes cutting multiple boards, forming individual wood stacks from the cut boards, re-arranging the wood stacks, interconnecting the re-arranged stacks forming at least third and fourth board and repeating the steps if desired. Also, the multiple boards and/or the third and fourth boards are a mirror image of each other.

### FIELD OF THE INVENTION

This invention relates in general to the manufacture of decorative boards of which may be used for producing designer products there from. More particularly the invention pertains to the process and/or a method for fabricating the boards from different types of materials of choice, such as wood in combination. Whereby the end result is a board(s) having a unique design formed thereon resulting from different intermixed colours and species of the different blended boards, materials and/or woods therein.

### BACKGROUND OF THE INVENTION

It is well known that products formed from wood are unusually beautiful especially due to the type of wood and the wood grains therein. Numerous types of wood are used depending on the various characteristics of choice, such as strength, colour, weight, cost, etc., all of which are considered before construction of the end product. For example, oak, cherry, maple and the like are often used for constructing furniture such as tables, dresser drawers, desks, etc. Still other types of wood are sought after specifically for their pleasant scent, such as cedar or the like. There are many different types of wood and there is a multitude of products constructed there from.

Most often the entire product is constructed from one type of wood and this has become the norm for the majority of carpenters. However, some carpenters have found that if different types of wood are intermixed the end result is unusually aesthetically pleasing. Within the known prior art attempts to integrate different types of wood into the construction of the product have been proposed. For example, a very old U.S. Pat. No. 2,062,175 entitled “METHOD OF MANUFACTURING INLAID WOOD ARTICLES” provides an interesting concept for making articles from different types of wood that are inlaid. The articles are appealing because they are somewhat unique, but the pattern of the inlaid wood is very restrictive, extremely uniform and monotonous when viewed. Also, importantly the method for manufacture is exceptionally time-consuming and simply not cost effective.

Another example of known prior art is U.S. Pat. No. 4,486,371 entitled “PRODUCTION OF A DECORATIVE WOOD PANEL WITH SIMULATED WOOD INLAY”. Again this is an attempt to combine different types of wood for a decorative appearance. However, again this process or method of manufacture constructs a board having the same uniform and monotonous pattern.

Nowhere in the known prior art did the applicant discover any references which can produce a board having the most unusual aesthetic characteristics as taught within the present method of manufacture. It is therefore contended that there is a great need for advancement in the field of board construction and which has not heretofore been taught, conceived or suggested within the known prior art.

### OBJECTS AND ADVANTAGES OF THE PRESENT INVENTION

It is therefore a primary object of the present invention to provide a method for producing designer blended wood boards that is new and novel. The method creates a board(s) that is “one of a kind” and cannot be replicated.

Another object of the present invention is to provide a method for producing designer blended wood boards that is simple to create, economically feasible to produce and cost effective.

A most important object of the present invention is to provide a method for producing designer blended wood boards that creates a pattern that is non-uniform and exceptionally aesthetically pleasing when viewed.

Yet another object of the present invention is to provide a method for producing designer blended wood boards that can be transformed into any article of carpenter choice, such as a wooden box, a cane, a pool cue, a stein, etc.

Other objects and advantages will become apparent when taken into consideration with the following specification and drawings.

### BRIEF DESCRIPTION OF THE DRAWINGS

FIG. 1 is a perspective overview illustrating method steps (a)-(c).

FIG. 2 is a perspective overview illustrating method step (d).

FIG. 3 is a perspective overview illustrating method step (d).

FIG. 4 is a left side end view illustrating method steps (e)-(g).

FIG. 5 is a central end view illustrating method steps (e)-(g).

FIG. 6 is a right side end view illustrating method steps (e)-(g).

FIG. 7 is a right side end view illustrating method steps (e)-(g).

FIG. 8 is a central side end view illustrating method steps (e)-(g).

FIG. 9 is a right side end view illustrating method steps (e)-(g).

FIG. 10 is a left side end view illustrating method step (h).

FIG. 11 is a central side end view illustrating method step (h).

FIG. 12 is a right side end view illustrating method step (h).

FIG. 13 is a perspective overview illustrating method steps (i)-(p).

FIG. 14 is an end overview illustrating method steps (i)-(p).

FIG. 15 is a perspective overview illustrating method steps (q) and (d).

FIG. 16 is an end overview illustrating method step (d).

FIG. 17 is a left side end view illustrating method steps (e)-(g).

FIG. 18 is a central end view illustrating method steps (e)-(g).

FIG. 19 is a right side end view illustrating method steps (e)-(g).

FIG. 20 is a left side end view illustrating method step (h).

FIG. 21 is a central end view illustrating method step (h).

FIG. 22 is a right end view illustrating method step (h).

FIG. 23 is a perspective overview illustrating method steps (i)-(p).

FIG. 24 is an end overview illustrating method steps (i)-(p).

### DETAILED DESCRIPTION OF THE DRAWINGS

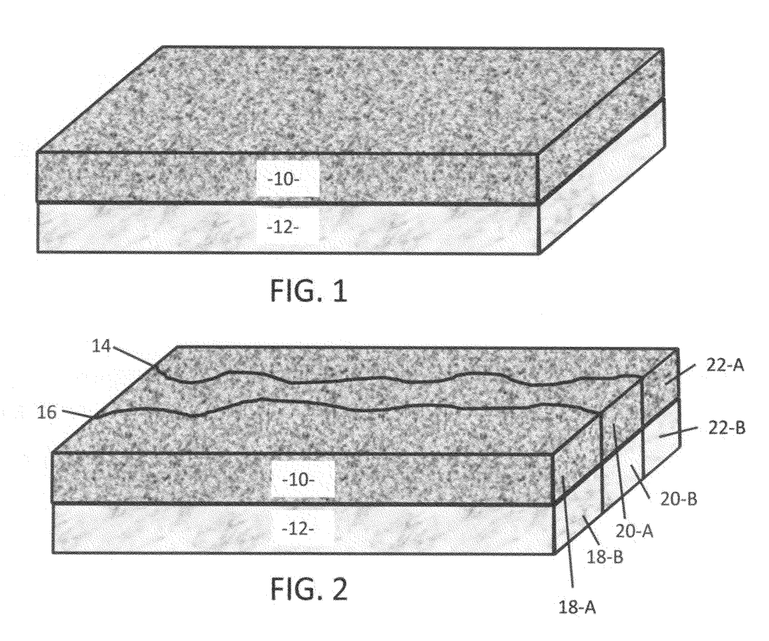

Referring now in detail to the drawings wherein like characters refer to like elements throughout the various views. FIG. 1 illustrates the method steps (a)-(c) initiated by the carpenter for creating the final designer blended wood board of the present invention. The carpenter first chooses multiple boards of equal length but may vary in width. The boards are each made from different types of wood having a different appearance in colour and/or texture if desired. Such as a first board (10) and a second board (12). The carpenter positions the first board (10) on top of the second board (12) in alignment with each other. Thereafter the boards (10 & 12) are removably attached together by any suitable fastening means of engineering choice, such as by wood screws, finishing nails, clamps or the like. It is to be understood the actual fastening means are not shown herein, as many different types of fasteners are well known within the prior art and thus their construction and installation does not need to be taught herein. Nor is the invention restricted to use of any particular type of fastening means. The method steps (a)-(c) for manufacture is now completed as illustrated in FIG. 1.

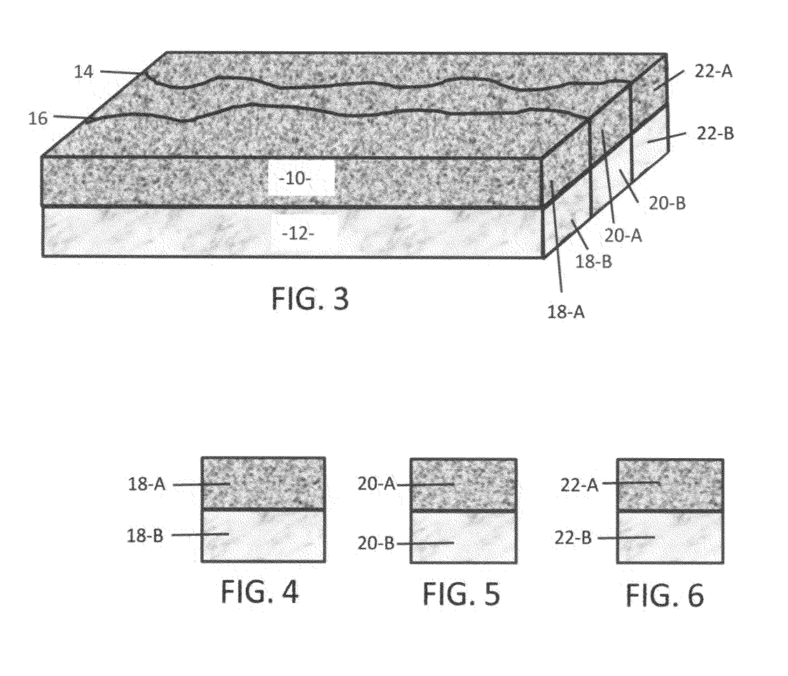

Referring now to FIGS. 2 & 3, of which illustrates the method step (d) for manufacture of the present invention. The carpenter then cuts the boards (10 & 12) downwards and lengthwise from end to end forming a first cut (14) and a second cut (16). Each cut (14 & 16) should be artistic in character (not straight or uniform) and made in a random non-uniform motion, respectively. It is to be understood that the carpenter can cut as many times as they wish. However, for clarity purposes the current example is only cut twice. The boards when cut form a first stack of boards (18), a second stack of boards (20), and a third stack of boards (22). The first stack of boards includes a top board (18-A) and a bottom board (18-B). The second stack of boards includes a top board (20-A) and a bottom board (20-B). The third stack of boards includes a top board (22-A) and a bottom board (22-B). The top board (18-A) of the first stack of boards (18) has a horizontally straight and vertically straight left side edge and a horizontally straight but vertically non-straight sliced right side edge. The bottom board (18-B) of the first stack of boards (18) has a horizontally straight and vertically straight left side edge and a horizontally straight but vertically non-straight sliced right side edge. The top board (20-A) of the second stack of boards (20) has a horizontally straight but vertically non-straight sliced left side edge and a horizontally straight but vertically non-straight sliced right side edge. The top board (22-A) of the third stack of boards (22) has a horizontally straight and vertically straight right side edge and a horizontally straight but vertically non-straight sliced left side edge. The method (d) for manufacture is now completed as illustrated in FIGS. 2 and 3.

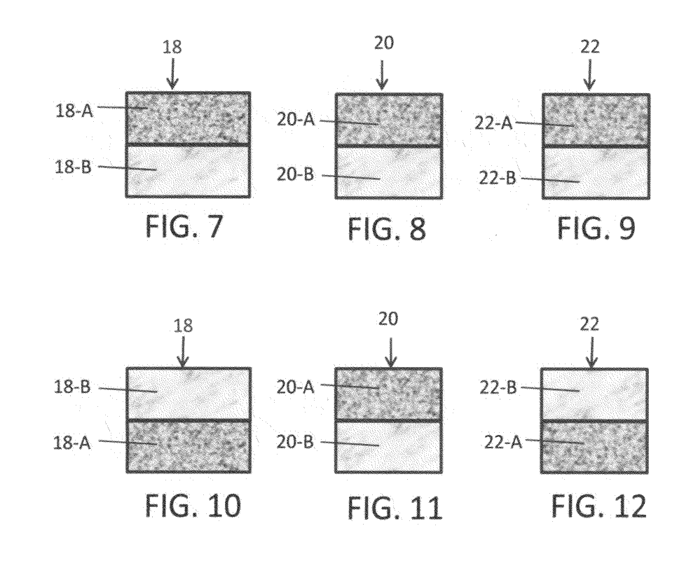

Referring now to FIGS. 4-9, of which illustrate the method steps (e)-(g) for manufacture of the present invention. The carpenter now separates each of the stacks of boards (18, 20 & 22) and positions them perpendicular onto a flat surface, substantially arranged in the same position before cutting yet spaced apart and distanced from each other as illustrated in FIGS. 4-9. The carpenter removes the fasteners (not shown). Note, fastener removal is not shown as this is a common procedure within the field of carpentry. The method steps (e)-(g) for manufacture is now completed as illustrated in FIGS. 4-9.

Referring now to FIGS. 10-12, of which illustrate method step (h) for manufacture of the present invention. The carpenter now repositions every other stack of boards as follows: The bottom board (18-B) of the first stack of boards (18) is slid ably removed from underneath the top board (18-A) and positioned on top of the top board (18-A). Thus, the horizontally straight and vertically straight left side edge of the top board (18-A) and the horizontally straight and vertically straight left side edge of the bottom board (18-B) are in vertical alignment and the horizontally straight but vertically non-straight sliced right side edge of the top board (18-A) and the horizontally straight but vertically non-straight sliced right side edge of the bottom board (18-B) are in vertical alignment. The carpenter leaves the second stack of boards (20) in their current position. Then the bottom board (22-B) of the third stack of boards (22) is slid ably removed from underneath the top board (22-A) and positioned on top of the top board (22-A). Thus, the horizontally straight and vertically straight right side edge of the top board (22-A) and the horizontally straight and vertically straight right side edge of the bottom board (22-B) are in vertical alignment and the horizontally straight but vertically non-straight sliced left side edge of the top board (22-A) and the horizontally straight but vertically non-straight sliced left side edge of the bottom board (18-B) are in vertical alignment. This method step interchanges the colours and more importantly produces creative artistic blending when the final board is constructed. This method step further includes the carpenter cleaning each of the boards (such as with compressed air) so as to remove any dust and/or foreign debris. This further provides nice clean surfaces to facilitate a flush fit between the boards when glued together during the next step. The method step (h) for manufacture is now completed as illustrated in FIGS. 10-12.

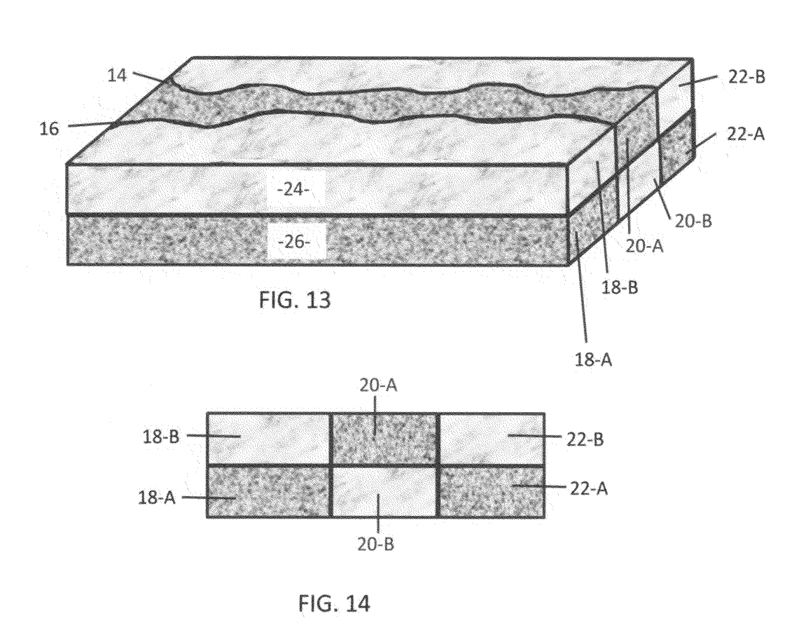

Referring now to FIGS. 13 & 14, of which illustrate the method steps (i)-(p) for manufacture of the present invention. The carpenter now glues the stacks of boards together in the following manner. The carpenter applies a thin uniform layer of glue onto the horizontally straight but vertically non-straight sliced right side edge of the top board (which is now 18-B). The carpenter then positions the horizontally straight but vertically non-straight sliced left side edge of the top board (20-A) against the horizontally straight but vertically non-straight sliced right side edge of the top board (which is now 18-B) and presses them together to distribute the glue evenly and affix them together. Then the carpenter applies a thin uniform layer of glue onto the horizontally straight but vertically non-straight sliced right side edge of the top board (which is now 20-A). The carpenter then positions the horizontally straight but vertically non-straight sliced left side edge of the top board (which is now 22-B) against the horizontally straight but vertically non-straight sliced left side edge of the top board (which is now 20-A) and presses them together to distribute the glue evenly and affix them together. Whereby, after the glue is cured the boards 18-B, 20-A and 22-B) are now affixed together side by side. Thus in combination the boards (18-B, 20-A and 22-B) produce an integrally formed new top board (24) and/or third board, as depicted in FIG. 13. Thereafter, the carpenter repeats the process above as follows to produce a second integrally formed new bottom board (26) and/or fourth board, as depicted in FIG. 13.

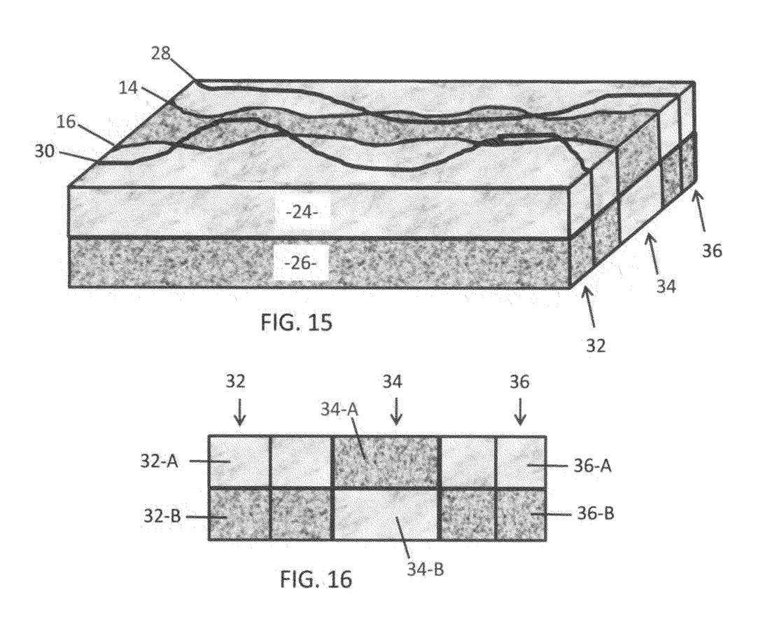

The carpenter applies a thin uniform layer of glue onto the horizontally straight but vertically non-straight sliced right side edge of the bottom board (which is now 18-A). The carpenter then positions the horizontally straight but vertically non-straight sliced left side edge of the bottom board (20-B) against the horizontally straight but vertically non-straight sliced right side edge of the bottom board (which is now 18-A) and presses them together to distribute the glue evenly and affix them together. Then the carpenter applies a thin uniform layer of glue onto the horizontally straight but vertically non-straight sliced right side edge of the bottom board (which is now 20-B). The carpenter then positions the horizontally straight but vertically non-straight sliced left side edge of the bottom board (which is now 22-B) against the horizontally straight but vertically non-straight sliced left side edge of the bottom board (which is now 22-A) and presses them together to distribute the glue evenly and affix them together. Whereby, after the glue is cured the boards 18-A, 20-B and 22-A) are now affixed together side by side. Thus in combination the boards (18-A, 20-B and 22-A) produce an integrally formed new bottom board (26) as depicted in FIG. 13. The carpenter then removes the fasteners (again fastener removal is not shown). Thereafter the carpenter finishes the top surface of each new board with a surface planer resulting in a smooth and level top surface for each new board. Also, this process results in each new board (24 & 26) having two types of wood blended therein of which are now designer boards which can't be replicated. It is to be understood that the new boards are different from each other however one is a mirror image of the other. This finalizes the general method and the third and fourth boards (24 & 26) can now be utilized to create an article of carpenter choice. However, the carpenter may choose to repeat the method with the new boards as illustrated in FIGS. 15-24 as follows:

Referring now to FIG. 15, of which illustrates method steps (q) & (d). The carpenter positions the first board (24) on top of the second board (26) in alignment with each other. Thereafter the boards (24 & 26) are removably attached together by any suitable fastening means of engineering choice.

Referring now to FIG. 16, of which illustrates method step (d). The carpenter then cuts the boards (24 & 26) downwards and lengthwise from end to end forming a first cut (28) and a second cut (30). Each cut (24 & 30) should be artistic in character (not straight or uniform) and made in a random non uniform motion, respectively. It is to be understood that the carpenter can cut as many times as they wish. However, for clarity purposes the current example is only cut twice again, (a total of 4 times throughout the entire process).

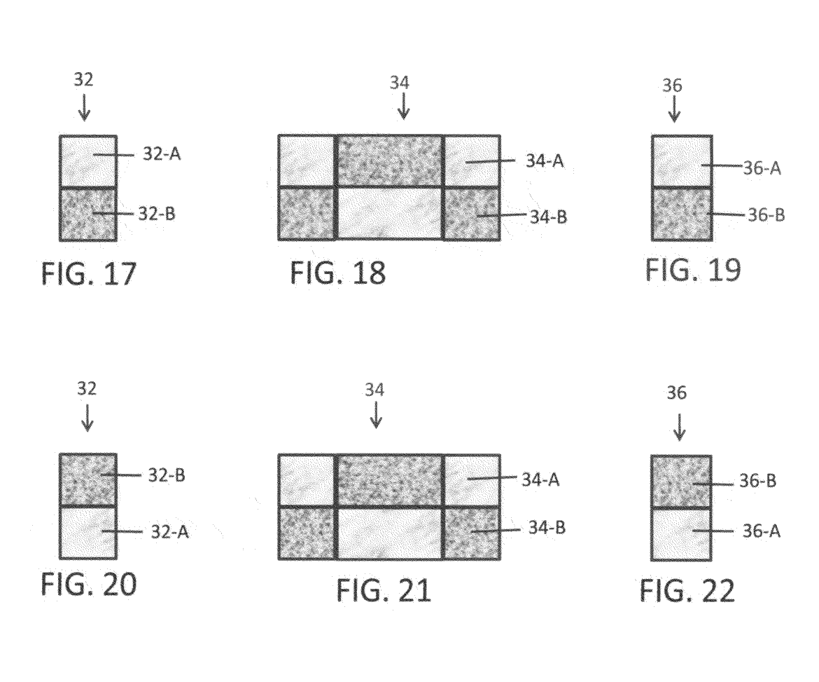

Referring now to FIGS. 17-19 of which illustrate the method steps (e)-(g). The boards when cut form a first stack of boards (32), a second stack of boards (34), and a third stack of boards (36). The first stack of boards includes a top board (32-A) and a bottom board (32-B). The second stack of boards includes a top board (34-A) and a bottom board (34-B). The third stack of boards includes a top board (36-A) and a bottom board (36-B). The top board (32-A) of the first stack of boards (32) has a horizontally straight and vertically straight left side edge and a horizontally straight but vertically non-straight sliced right side edge. The bottom board (32-B) of the first stack of boards (32) has a horizontally straight and vertically straight left side edge and a horizontally straight but vertically non-straight sliced right side edge. The top board (34-A) of the second stack of boards (34) has a horizontally straight but vertically non-straight sliced left side edge and a horizontally straight but vertically non-straight sliced right side edge. The top board (36-A) of the third stack of boards (36) has a horizontally straight and vertically straight right side edge and a horizontally straight but vertically non-straight sliced left side edge. The carpenter now separates each of the stacks of boards (32, 34 & 36) and positions them perpendicular onto a flat surface, substantially arranged in the same position before cutting yet spaced apart and distanced from each other as illustrated in FIGS. 17-19. The carpenter removes the fasteners (not shown).

Referring now to FIGS. 20-22, of which illustrates method step (h). The carpenter now repositions every other stack of boards as follows: The bottom board (32-B) of the first stack of boards (32) is slid ably removed from underneath the top board (32-A) and positioned on top of the top board (32-A). Thus, the horizontally straight and vertically straight left side edge of the top board (32-A) and the horizontally straight and vertically straight left side edge of the bottom board (32-B) are in vertical alignment and the horizontally straight but vertically non-straight sliced right side edge of the top board (32-A) and the horizontally straight but vertically non-straight sliced right side edge of the bottom board (32-B) are in vertical alignment. The carpenter leaves the second stack of boards (34) in their current position. Then the bottom board (36-B) of the third stack of boards (36) is slid ably removed from underneath the top board (36-A) and positioned on top of the top board (36-A). Thus, the horizontally straight and vertically straight right side edge of the top board (36-A) and the horizontally straight and vertically straight right side edge of the bottom board (36-B) are in vertical alignment and the horizontally straight but vertically non-straight sliced left side edge of the top board (36-A) and the horizontally straight but vertically non-straight sliced left side edge of the bottom board (36-B) are in vertical alignment. Again, this method step interchanges the colours and more importantly produces creative artistic blends when the final board is constructed. This method step again includes the carpenter cleaning each of the boards (such as with compressed air) so as to remove any dust and/or foreign debris. This further provides nice clean surfaces to facilitate a flush fit between the boards when glued together during the next step.

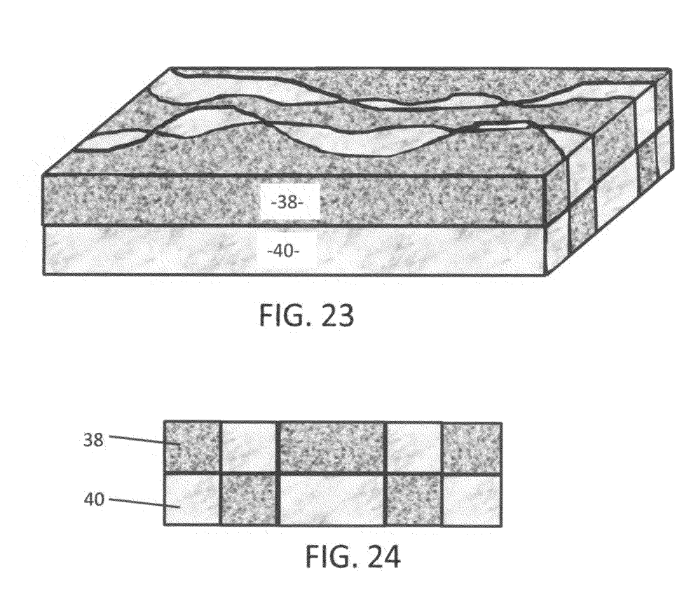

Referring now to FIGS. 23 & 24 of which illustrates method steps (i)-(p). The carpenter now glues the stacks of boards together in the following manner. The carpenter applies a thin uniform layer of glue onto the horizontally straight but vertically non-straight sliced right side edge of the top board (which is now 32-B). The carpenter then positions the horizontally straight but vertically non-straight sliced left side edge of the top board (34-A) against the horizontally straight but vertically non-straight sliced right side edge of the top board (which is now 32-B) and presses them together to distribute the glue evenly and affix them together. Then the carpenter applies a thin uniform layer of glue onto the horizontally straight but vertically non-straight sliced right side edge of the top board (which is now 34-A). The carpenter then positions the horizontally straight but vertically non-straight sliced left side edge of the top board (which is now 36-B) against the horizontally straight but vertically non-straight sliced right side edge of the top board (which is now 34-A) and presses them together to distribute the glue evenly and affix them together. Whereby, after the glue is cured the boards 32-B, 34-A and 36-B) are now affixed together side by side. Thus in combination the boards (32-B, 34-A and 36-B) produce another integrally formed new top board (38) as depicted in FIG. 23. Thereafter, the carpenter repeats the process above as follows to produce another integrally formed new bottom board (40) as depicted in FIG. 23.

The carpenter applies a thin uniform layer of glue onto the horizontally straight but vertically non-straight sliced right side edge of the bottom board (which is now 32-A). The carpenter then positions the horizontally straight but vertically non-straight sliced left side edge of the bottom board (34-B) against the horizontally straight but vertically non-straight sliced right side edge of the bottom board (which is now 32-A) and presses them together to distribute the glue evenly and affix them together. Then the carpenter applies a thin uniform layer of glue onto the horizontally straight but vertically non-straight sliced right side edge of the bottom board (which is now 34-B). The carpenter then positions the horizontally straight but vertically non-straight sliced left side edge of the bottom board (which is now 36-A) against the horizontally straight but vertically non-straight sliced right side edge of the bottom board (which is now 34-B) and presses them together to distribute the glue evenly and affix them together. Whereby, after the glue is cured the boards 32-A, 34-B and 36-A) are now affixed together side by side. Thus in combination the boards (32-A, 34-B and 36-A) produce another integrally formed new bottom board (40) as depicted in FIG. 23. The carpenter then removes the fasteners (again fastener removal is not shown). Thereafter the carpenter finishes the top surface of each new board with a surface planer resulting in a smooth and level top surface for each new board. Also, this process results in each new board (24 & 26) having two types of wood blended therein of which are now designer boards which can't be replicated. It is to be understood that the new boards are different from each other however one is a mirror image of the other. This finalizes the general method and the boards (38 & 40) can now be utilized to create an article of carpenter choice. However, the carpenter may again choose to repeat the method as many times as they wish. Whereby, every time repeated will produce a board(s) having more and more beautiful blending. Although it is to be noted that each successive time the boards become thinner due to the surface planer removing small portions there from.

It is to be understood there are many possible variations for accomplishing the desired end results. For example, different ways of aligning the boards together, different ways of gluing and different ways of attaching. Whereby, the drawings and method steps as described herein are only exemplary. Also it is to be understood the material the boards are constructed from can be any suitable material of engineering choice, such as wood, plastic, metal, Vinyl, flooring, etc.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

What I claim as new and wish to secure by Letters Patent is:

1. Method for manufacture of designer blended wood boards, the method utilizing multiple boards such as a first board (i) a second board (ii), a carpenter (iii) fasteners (iiii) a saw (iiiii) glue (iiiiii) and a surface planer, the method steps comprising:
(a) choosing multiple boards, such as a first board and a second board, said first board and said second board are made from different types of materials of choice, such as wood having a different appearance in colour and/or texture;
(b) positioning said first board on top of said second board in alignment with each other;
(c) attaching said first board onto said second board with fasteners;
(d) cutting downwards and lengthwise from end to end forming a first cut and a second cut, each said cut should be artistic and not straight or uniform, after said first board and said second board are cut, a first stack of boards, a second stack of boards and a third stack of boards are formed, each said stack of boards include a top board and a bottom board;
(e) separating said first stack of boards, said second stack of boards and said third stack of boards as follows;
(f) positioning said first stack of boards, said second stack of boards and said third stack of boards perpendicular onto a flat surface, arranged in the same position before cutting yet spaced apart and distanced from each other;
(g) removing fasteners;
(h) repositioning said first stack of boards, said second stack of boards and said third stack of boards in the following manner, said bottom board of said first stack of boards is slid ably removed from underneath said top board of said first stack of boards and repositioned on top of said top board of said first stack of boards, said second stack of boards remains in the current position and said bottom board of said third stack of boards is slid ably removed from underneath said top board of said third stack of boards and repositioned on top of said top board of said third stack of boards;
(i) applying glue onto the right side edge of said top board of said first stack of boards;
(j) positioning the left side edge of said top board of said second stack of boards against said right side edge of said top board of said first stack of boards;
(k) applying glue onto the right side edge of said top board of said second stack of boards;
(l) positioning the left side edge of said top board of said third stack of boards against said right side edge of said top board of said second stack of boards;
(m) applying glue onto the right side edge of said bottom board of said first stack of boards;
(n) positioning the left side edge of said bottom board of said second stack of boards against said right side edge of said bottom board of said first stack of boards;
(o) applying glue onto the right side edge of the bottom board of said second stack of boards; and
(p) positioning the left side edge of said bottom board of said third stack of boards against said right side edge of said bottom board of said second stack of boards;
whereby: after said glue has cured, a third board and a fourth board are constructed, and said third board and said fourth board each have different types of wood intermixed there through.

2. The method for manufacture of designer blended wood boards of claim 1 further includes the method steps of;
(q) positioning said third board on top of said fourth board;
(r) attaching said third board onto said fourth board with fasteners; and
(s) repeating steps (d)-(p).
